(19) United States
(12) Patent Application Publication
(10) Pub. No.: US 2006/0057397 A1
(43) Pub. Date: Mar. 16, 2006

(54) Fiber-reinforced laminates

(75) Inventors: Rami-Raimund Awad, Graz (AT); Florian Lunzer, Graz (AT)

Correspondence Address: CONNOLLY BOVE LODGE & HUTZ, LLP, P O BOX 2207, WILMINGTON, DE, 19899, US

(73) Assignee: Surface Specialties Austria GmbH, Werndorf (AT)

(21) Appl. No.: 11/266,946

(22) Filed: Nov. 4, 2005

Related U.S. Application Data
(62) Division of application No. 10/706,111, filed on Nov. 12, 2003, now abandoned.

(30) Foreign Application Priority Data
Nov. 15, 2002 (AU) AU 1725/2002

(51) Int. Cl. B32B 27/40

(52) U.S. Cl. 428/423.1; 427/487

(57) ABSTRACT

Fiber-reinforced laminates comprising at least two layers at least one of which comprises a polymer curable by irradiation with high-energy light, processes for producing them, and their use.

### FIELD OF THE INVENTION

The invention relates to fiber-reinforced laminates having at least two layers.

### BACKGROUND OF THE INVENTION

The production of laminates comprising reinforcing fibers and free-radically or thermally curable polymers has been known. Unsaturated polyesters are normally used for this purpose. These polyesters frequently include relatively large amounts of copolymerizable monomers, customarily styrene, which within the mixture lower the viscosity of the curable mixture and provide good formability, by casting, winding or laying, for example. In the course of processing it is easy for this styrene to escape from the curable compositions owing to the high surface area; such escape causes environmental and occupational hygiene problems.

### SUMMARY OF THE INVENTION

It is therefore the object of the invention to provide fiber-reinforced laminates and binders therefor which without such addition of styrene produce moldings having smooth, esthetic surfaces and good thermoformability prior to ultimate curing.

This object is achieved through the use of binders, at least of one outer layer, which are curable by irradiation with high-energy light.

The invention accordingly provides fiber-reinforced laminates having at least two layers wherein an outer layer A′ containing a polymer A containing allyl groups, acrylic groups and/or methacrylic groups and being curable by high-energy radiation and an adjacent layer comprises reinforcing fibers and a curable composition B′ comprising a polymer B selected from systems polymerizable free-radically (B1) and by irradiation with high-energy light (B2).

The invention further provides a process for producing cured laminates which comprises the steps of (1) producing a cured polymer layer A′ from a polymer A by irradiation with high-energy light and (2) applying a further layer to the layer A′ produced in step (1), the further layer comprising reinforcing fibers and a curable composition B′ which originates by free-radical polymerization from a free-radically polymerizable system B1 and/or by irradiation of a system B2 with high-energy light.

The invention likewise provides a process for producing shaped laminates which comprises bringing the incompletely cured laminates into the desired shape under the action of heat and pressure and subsequently curing them.

### DETAILED DESCRIPTION OF THE PREFERRED EMBODIMENTS

In particular, first of all, a molding or a surface of a smooth substrate is coated with a layer Z which has an antiadhesive effect, after which in step (1) this layer is coated with a composition comprising a substance A polymerizable by irradiation with high-energy light, the substance A being polymerized by irradiation and so cured, in step (2) the free surface of this layer is coated with a curable composition B′ comprising a polymer B selected from systems polymerizable free-radically (B1) and by irradiation with high-energy light (B2) and reinforcing fibers, and then the curable composition B′ is at least partly cured, and then detached from the surface or molding for ultimate curing.

The polymers A and B2 are selected independently of one another from epoxy acrylates, urethane acrylates, melamine acrylates, polyether acrylates, polyester acrylates, the corresponding methacrylates, and esters of other olefinically unsaturated acids, and polyesters or polyethers both containing allyl groups, and also mixtures thereof.

Epoxy acrylates are reaction products of epoxy resins C with carboxyl group-containing olefinically unsaturated compounds G. As epoxy resins C it is possible to use the glycidyl ethers of dihydroxyaromatics such as resorcinol, dihydroxybenzophenone, dihydroxydiphenylsulfone, and, preferably, bisphenol A and bisphenol F; it is also possible to use glycidyl ethers of aliphatic diols such as butanediol and hexanediol, and also epoxy resins of higher molar mass, which are obtainable preferentially from bisphenol A and/or bisphenol F by the Taffy process (reaction of these bisphenols with epichlorohydrin) and by the so-called advancement reaction (reaction of bisphenol diglycidyl ethers with the free bisphenols). It is also possible to use epoxy resins based on novolaks and epoxidized oils.

Carboxyl group-containing olefinically unsaturated compounds G which can be used here are in particular acrylic acid and methacrylic acid, but also crotonic acid, vinylacetic acid, and the monoesters of olefinically unsaturated dicarboxylic acids, such as monomethyl maleate, monomethyl fumarate, and the monoalkyl esters of citraconic, itaconic, and mesaconic acids. Preference is given to the first-mentioned acrylic acid and methacrylic acid.

Urethane acrylates are reaction products D(E)F of polyfunctional isocyanates D and hydroxyl group-containing olefinically unsaturated compounds F and also, where appropriate, polyfunctional aliphatic alcohols E.

The polyfunctional isocyanates D are at least difunctional and can be selected from aromatic and aliphatic linear, cyclic, and branched isocyanates, especially diisocyanates. Preference is given to diisocyanates, where it is possible for up to 5% of their mass to be replaced by isocyanates having a functionality of three or more.

The diisocyanates preferably possess the formula Q(NCO)₂, where Q is a hydrocarbon radical having 4 to 40 carbon atoms, in particular 4 to 0.20 carbon atoms, and preferably an aliphatic hydrocarbon radical having 4 to 12 carbon atoms, a cycloaliphatic hydrocarbon radical having 6 to 15 carbon atoms, an aromatic hydrocarbon radical having 6 to 15 carbon atoms or an araliphatic hydrocarbon radical having 7 to 15 carbon atoms. Examples of such diisocyanates for use with preference are tetramethylene diisocyanate, hexamethylene diisocyanate, dodecamethylene diisocyanate, 1,4-diisocyanatocyclohexane, 3-isocyanato-methyl-3,5,5-trimethylcyclohexyl isocyanate (isophorone diisocyanate, IPDI), 4,4′-diisocyanatodicyclohexylmethane, 2,2-bis (4-isocyanatocyclohexyl)propane, 1,4-diisocyanato-benzene, 2,4- or 2,6-diisocyanatotoluene and mixtures of these isomers, 4,4′- or 2,4′-diisocyanatodiphenylmethane, 2,2-bis(4-isocyanatophenyl)propane, p-xylylene diiso-cyanate, and α,α,α′,α′-tetramethyl-m- or -p-xylylene diisocyanate, and mixtures of these compounds.

In addition to these simple polyisocyanates, also those are suitable which contain heteroatoms in the radical linking the isocyanate groups. Examples of such are polyisocyanates containing carbodiimide groups, allophanate groups, isocyanurate groups, urethane groups, acylated urea groups or biuret groups. For further suitable polyisocyanates reference may be made, for example, to DE-A 29 28 552.

The polyfunctional aliphatic alcohols E used if desired have at least two hydroxyl groups per molecule and 2 to 150 carbon atoms, preferably 3 to 40, and in particular 4 to 20 carbon atoms. They can be linear, branched or cyclic and can also contain heteroatoms, such as ether bonds, ester bonds or secondary or tertiary amine bonds, in the molecule. Compounds of this kind are ether alcohols or polyether alcohols such as polyethylene glycol, polypropylene glycol, mixtures thereof and copolymers and polyoxybutylenediol (“poly-THF”), and also polyester alcohols and amino alcohols. Preference is given to glycol, 1,2- and 1,3-propanediol, 1,2- and 1,4-butanediol, neopentylglycol, 1,6-hexanediol, trimethylolethane, glycerol, trimethylolpropane, erythritol, pentaerythritol, sorbitol, mannitol, ditrimethylolethane, diglycerol, ditrimethylolpropane, diethylene glycol, triethylene glycol, di- and tri-propylene glycol, diethanolamine, N-methyldiethanolamine, triethanolamine, ethoxylated trimethylolpropane, and ethoxylated glycerol.

Particular preference is given to 1,4-butanediol, and 1,6-hexanediol.

The hydroxyl group-containing ethylenically unsaturated compounds F are aliphatic mono- or polyunsaturated compounds having 3 to 20 carbon atoms and at least one hydroxyl group. Particular preference is given to allyl alcohol and to the monoesters of dihydric alcohols F1 with the abovementioned olefinically unsaturated acids G, such as hydroxyethyl acrylate, hydroxyethyl methacrylate, 2- and 3-hydroxypropyl (meth)acrylate, 1-hydroxy-2-propyl (meth)acrylate, 4-hydroxybutyl (meth)acrylate, and 6-hydroxyhexyl (meth)acrylate, esters of trihydric or higher polyhydric alcohols with an acid containing olefinically unsaturated groups, with at least one hydroxyl group remaining unesterified, examples being trimethylolpropane di(meth)acrylate, pentaerythritol tri(meth)acrylate, and the acrylates and methacrylates formed by reacting (meth)acrylic acid with 1,2-epoxy compounds, in particular with esters or ethers of glycidyl alcohol with monovalent aliphatic alcohols or acids which preferably contain tertiary or quaternary carbon atoms. Examples of such compounds are the ester of glycidyl alcohol with α-branched aliphatic monocarboxylic acids having 5 to 12 carbon atoms.

Melamine acrylates are reaction products of hydroxyl group-containing olefinically unsaturated compounds F with alkylolmelamines obtained by reacting melamine and aldehydes, especially formaldehyde. Melamine acrylates are prepared in particular by transetherification of hexamethoxymethylmelamine with the compounds F. It is also possible to etherify the compounds F directly with methylolated melamine, for example, hexamethylolmelamine, this process, however, is not carried out on the industrial scale.

Polyether acrylates are esters of polyalkylene glycols having degrees of polymerization of preferably from 4 to 100, especially polypropylene glycol, poly(oxy-1,4-butylene) glycol and mixed copolymers having oxyethylene and oxypropylene units, with the olefinically unsaturated acids specified under G; they are normally prepared by transesterification with ethyl (meth)acrylate or similar esters.

Polyester acrylates are esterification products of olefinically unsaturated acids G with hydroxyl group-containing polyols or polyesters or esterification products of hydroxyl group-containing olefinically unsaturated compounds F with acid groups of a polyester. The polyesters are normally derived from linear or branched aliphatic polyols having two or more hydroxyl groups and from 2 to 20 carbon atoms, such as glycol, neopentylglycol, butanediol, 1,6-hexanediol, diethylene and triethylene glycol, trimethylolpropane, pentaerythritol, and sorbitol, and aliphatic linear or cyclic dicarboxylic acids such as adipic acid and cyclohexanedicarboxylic acid, the hydroxyl group-containing polyether polyols based on ethylene oxide and propylene oxide or mixtures thereof and on polytetrahydrofuran, and also on ethoxylated and/or propoxylated polyhydric alcohols, such as those mentioned above.

Where “acrylates” are referred to above, in the context of the disclosure these acrylates also of course include the corresponding methacrylates and the esters of the other acids mentioned under G.

Allyl group-containing compounds are ethers or esters or mixed ether-esters of allyl alcohol with polyhydric alcohols or their ethoxylation and/or propoxylation products or allyl esters of the abovementioned aliphatic carboxyl group-containing polyesters.

The unsaturated polyesters B1 are styrene-free polyesters based on allyl ethers of polyhydric alcohols, the number of allyl groups always being less by one than the number of hydroxyl groups of the unetherified alcohol, aliphatic linear, branched or cyclic diols having 2 to 20 carbon atoms, olefinically unsaturated dicarboxylic acids having 4 to 20 carbon atoms, such as fumaric acid in particular, and small amounts of monohydric alcohols, especially benzyl alcohol, the amount of the latter being such that crosslinking through the polyunsaturated compounds is kept within limits.

Suitable reinforcing fibers are glass fibers in particular but also carbon fibers, aramid fibers, particularly those of the so-called high-modulus polymers such as poly-para-phenyleneterephthalamide (®Kevlar or ®Twaron) and copolymers (e.g., ®Teijin HM50) containing more than 30% of units derived from terephthalic acid and para-phenylenediamine, and also fibers of liquid-crystalline polyesters and fibers of ultrahigh molar mass polyethylene (e.g., ®Dyneema).

As antiadhesive layer Z it is possible to use a standard release agent (for example, waxes, silicone-modified waxes, fatty acid amide waxes, salts of long-chain fatty acids like zinc stearate, polyvinyl alcohol, fluorinated polymers, and natural phospholipids such as soya lecithin).

The laminates of the invention can be employed in all applications where use has been made to date, for example, of laminates comprising glass fiber mats with unsaturated polyesters with a gel coat surface.

### EXAMPLES

### Example 1

Areas of glass coated with soya lecithin as antiadhesive layer were coated with white-pigmented layers of radiation-curable mixtures according to table 1, in film thicknesses of 600, 400, and 200 μm. The coatings were cured by irradiation with UV light (2 gallium-doped mercury lamps and 2 undoped mercury lamps, each with a power of 80 W/cm based on the arc length) at different speeds of travel through the irradiation zone.

TABLE 1
Composition of the coating materials in g

| Coating | 1 | 2 | 3 | 4 | 5 | 6 | 7 |
|---|---|---|---|---|---|---|---|
| unsaturated | 100 | 50 | 100 | | 100 | 100 | 50 |
| polyester¹ | | | | | | | |
| epoxy acrylate² | | 50 | | | | | 50 |
| urethane | | | | 100 | | | |
| acrylate³ | | | | | | | |
| color paste⁴ | 10 | 10 | 20 | 20 | 20 | 20 | 20 |
| photoinitiator⁵ | 4.6 | 4.8 | 5 | 5 | | | |
| photoinitiator⁶ | | | | | 5 | 4.8 | 5.2 |
| devolatilizer⁷ | 0.3 | 0.3 | 03 | 0.3 | 0.3 | 0.3 | 0.3 |
| reactive | 15 | 20 | 25 | 25 | 25 | | |
| diluent⁸ | | | | | | | |
| reactive | | | | | | 20 | 30 |
| diluent⁹ | | | | | | | |
| viscosity¹⁰ | 1113 | 1567 | 803 | 1009 | 756 | 841 | 798 |
| in mPa · s | | | | | | | |

Key:
¹unsaturated polyester (100%) containing units derived from trimethylolpropane diallyl ether (40%), benzyl alcohol (5%), diethylene glycol (15%), and fumaric acid (40%), the mass fractions being based on the mass of the polyester
²epoxy acrylate based on a bisphenol A epoxy resin with a weight-average molar mass of approximately 700 g/mol
³urethane acrylate based on aliphatic polyols, an aliphatic diisocyanate, and a mixture of hydroxyalkyl (meth)acrylates
⁴white color paste based on unsaturated polyester, ® Viapal 9010 OEP, Surface Specialties Austria GmbH
⁵photoinitiator mixture ® Irgacure 184 (hydroxycyclohexyl phenyl ketone) and ® Irgacure 819 (phenyl-2,4,6-trimethylbenzoylphosphine oxide), equal mass fractions, Ciba Specialty Chemicals
⁶photoinitiator mixture ® Irgacure 184, Ciba Specialty Chemicals, and ® Lucirin TPO (triphenylphosphine oxide), BASF AG, equal mass fractions
⁷devolatilizer ® TEGO Airex 920, Th. Goldschmidt GmbH
⁸dipropylene glycol diacrylate
⁹triethylene glycol dimethacrylate
¹⁰measured in accordance with DIN EN ISO 3219 at 23° C.

After curing at the belt speeds indicated, the irradiated side of the glass plate was laminated with an unsaturated polyester resin (®Viapal VUP 4782/BEMT 55; Co peroxide system) reinforced with glass fiber mats, after which the system was detached from the glass plate. The results obtained are summarized in table 2.

TABLE 2
Results

| | | Layer thickness | | |
|---|---|---|---|---|
| Coating | Speed | 600 μm | 400 μm | 200 μm |
| 1 | 10 m/min | not scratch-resistant, | | good degree of cure, |
| | | excessive yellowing; | | structure of the glass |
| | | surface cracks at | | fiber mat can be seen, |
| | | 8 m/min | | low yellowing |
| 2 | 20 m/min | very hard surface, | | good degree of cure, |
| | | severe yellowing, | | structure of the glass |
| | | excessive contraction | | fiber mat can be seen, |
| | | after lamination | | low yellowing |
| 3 | 10 m/min | inadequate degree of | inadequate degree of | inadequate degree of |
| | | cure, sensitive to | cure, sensitive to | cure, sensitive to |
| | | scratching, severe | scratching, structure of | scratching, structure |
| | | yellowing | the glass fiber mat can | of the glass fiber mat |
| | | | be seen, severe | can be seen, |
| | | | yellowing | unacceptable yellowing |
| 4 | 12 m/min | good degree of cure, | good degree of cure, | good degree of cure, |
| | | coating film elastic, | coating film very | structure of the glass |
| | | severe yellowing | elastic, severe | fiber mat can be seen, |
| | | | yellowing | unacceptable yellowing |
| 5 | 5 m/min | inadequate degree of | good degree of cure, no | good degree of cure, |
| | | cure, sensitive to | yellowing | smooth surface, no |
| | | scratching, no | | yellowing |
| | | yellowing | | |
| 6 | 5 m/min | inadequate degree of | inadequate degree of | inadequate degree of |
| | | cure, coating film | cure, coating film | cure, coating film is |
| | | remains soft, only | remains very soft, only | soft, only partly |
| | | partly gelled, no | partly gelled, no | gelled, no yellowing |
| | | yellowing | yellowing | |
| 7 | 8 m/min | good degree of cure, no | good degree of cure, no | good degree of cure, |
| | | yellowing, at higher | yellowing | smooth surface, no |
| | | belt speed no through- | | yellowing |
| | | cure | | |

| | | |
|---|---|---|
| Assessment: | degree of cure | good/soft/inadequate = only partial gelling |
| | sensitivity to scratching | insensitive/low/not measurable |
| | visibility of the glass fiber mat | none/slight/severe |
| | yellowing | none/slight/severe |

### Example 2

In a second series of experiments UV-curable coatings 2.1 and 2.2 according to table 3 were applied to glass plates as described in example 1 coated with release agent as above. The coatings were cured under 2 mercury lamps and 2 gallium-doped mercury lamps, each with a power of 80 W/cm, at a belt speed of 5 m/min from a distance of 10 cm, and after curing were detached from the glass plates and joined to a UV-curable laminating layer. This layer consisted of a 10×20 cm² glass fiber mat (approximately 5 g/m²) to which approximately 20 g of the UV laminating materials 2.3 and 2.4, in accordance with the indication in table 3, have been applied. Following lamination the laminate was cured by irradiation with UV light from the side of the impregnated glass fiber mat. The results are summarized in table 4.

TABLE 3
UV-curable coating materials (compositions
of the coating materials in g)

| Coating material | 2.1 | 2.2 | 2.3 | 2.4 |
|---|---|---|---|---|
| unsaturated polyester¹ | 100 | 50 | 100 | 50 |
| epoxy acrylate² | | 50 | | 50 |
| photoinitiator⁵ | 5 | 5.2 | 5 | 5.2 |
| devolatilizer⁶ | 0.3 | 0.3 | 0.3 | 0.3 |
| reactive diluent⁷ | 25 | | 25 | |
| reactive diluent⁸ | | 30 | | 30 |
| color paste⁹ | 20 | 20 | | |

For key see table 1

TABLE 4
Results

| Coating material | Layer thickness | Curing | Yellowing |
|---|---|---|---|
| 2.1 | 600 μm | good degree | no |
| | 400 μm | of cure | yellowing |
| 2.2 | 600 μm | good degree | no |
| | 400 μm | of cure | yellowing |
| | application rate | | |
| 2.3 | about 20 g to | good degree | no |
| | 10 × 20 cm² | of cure | yellowing |
| 2.4 | about 20 g to | good degree | no |
| | 10 × 20 cm² | of cure | yellowing |

### Example 3

In a third series of experiments glass fiber mats (10×20 cm²; approximately 5 g/m²) were applied to wood veneer (10×20 cm²) and laminated with UV-curable coatings 3.1 and 3.2 as per table 5 (application rate 20 g/m²), and cured using 2 mercury lamps each with a power of 8.0 W/cm at a belt speed of 10 m/min. This procedure gave a veneer/laminate composite in a rational work step, which in the case of a prior art process requires at least two work steps (preparation of the mold, e.g. an aluminum support, and fixing (adhesive bonding) of the veneer on or to the corresponding mold).

This molding (i.e. the veneer/laminate composite) was subsequently coated on the veneer side with a UV clearcoat material in accordance with coating 3.3 (see table 5), the clearcoat material being applied in one instance in 2 coats and in another instance with 3 coats, the wet thickness of each coat being 200 μm. The coating was cured again by exposure to 2 mercury lamps each with a power of 80 W/cm at a belt speed of 10 m/min. The surface coated with the UV clearcoat material and cured matches a high-build polyester coating that can be completed within a short time. In comparison, for lay-up operations in automobiles (dashboard, steering wheel, gearknob grip) a high-build polyester coating requires at least 6 or 7 applications each at a rate of approximately 250 g/m², possibly with subsequent sanding/polishing/buffing; the overall layer thickness at the end of the processing, operation is in that case about 700 to 800 μm; the coating operation takes about 4 to 5 hours, and finishing by sanding and polishing cannot take place until 72 h after the coating operation.

The results are summarized in table 6.

TABLE 5
UV-curable coating materials (compositions
of the coating materials in g)

| Coating material | 3.1 | 3.2 | 3.3 |
|---|---|---|---|
| unsaturated polyester¹ | 100 | 50 | |
| epoxy acrylate² | | 50 | |
| urethane acrylate³ | | | 85 |
| photoinitiator⁶ | 5 | 5.0 | |
| photoinitiator¹¹ | | | 4.7 |
| devolatilizer⁶ | 0.3 | 0.3 | 0.3 |
| reactive diluent⁸ | 25 | | 10 |
| reactive diluent⁹ | | 30 | |

For key see table 1

TABLE 6
Results

| Coating material | Layer thickness | Curing |
|---|---|---|
| 3.1 | about 20 g to 20 × 10 cm² | good degree of cure |
| 3.2 | about 20 g to 20 × 10 cm² | good degree of cure |
| 3.3 | 200 μm wet film | good degree of cure |

It is found that styrene-containing unsaturated polyester resins with the conventional free-radical curing by means of cobalt salts and peroxides can be replaced by styrene-free UV-curable systems. The advantage of these systems is the absence of styrene and the increased reactivity of the UV-curable system and consequent higher productivity. Veneer/laminate composites can be produced in one work step using the UV technology. The use of a UV clearcoat system to replace UP coating material produces a distinct increase in productivity owing to more rapid curing.

1-7. (canceled)

8. A process for producing a cured fiber-reinforced laminate having at least two layers wherein one outer layer A′ comprises a polymer A which contains groups selected from the group consisting of allyl groups, acrylic groups, and methacrylic groups, which polymer A is curable by irradiation with UV light and an adjacent layer which comprises reinforcing fibers and a curable composition B′ comprising a Polymer B selected from polymers (B1) that polymerise free-radically and polymers (B2) that polymerise by irradiation with UV light, comprising the steps of (1) producing a cured polymer layer A′ from a polymer A by irradiation with UV light and (2) applying a further layer to the layer A′ produced in step (1), the further layer comprising reinforcing fibers and a curable composition B′ which originates by free-radical polymerisation from polymers (B1) that polymerise free-radically and/or by irradiation of polymers (B2) that polymerise by irradiation with UV light.

9. A process for producing a shaped fiber-reinforced laminate having at least two layers wherein one outer layer A′ comprises a Polymer A which contains groups selected from the group consisting of allyl groups, acrylic groups, and methacrylic groups, which polymer A is curable by irradiation with UV light and an adjacent layer which comprises reinforcing fibers and a curable composition B′ comprising a polymer B selected from Polymers (B1) that polymerise free-radically and Polymers (B2) that polymerise by irradiation with UV light, which comprises in the first step coating a molding or an area of a smooth substrate with a layer Z which has an antiadhesive action, then in a second step coating this layer with a composition comprising a substance A polymerisable by irradiation with UV light, in the third step polymerising the substance A by irradiation and so curing it, in the fourth step coating the free surface of this layer with a curable composition B′ comprising reinforcing fibers and a polymer B selected from polymers (B1) that polymerise free-radically and polymers (B2) that polymerise by irradiation with UV light, in the fifth step at least partly curing the curable composition B′, and in the sixth step detaching this system from said area or said molding, the laminate formed being subsequently shaped under the action of heat and pressure while the composition B′ has not yet fully cured.

10. A process for producing a cured fiber-reinforced laminate, which comprises covering a flexible sheet selected from the group consisting of veneer, polymer films, and metal foil, with a layer comprising reinforcing fibers impregnated with a polymer A curable by irradiation with UV light and then curing the polymer-impregnated fiber layer by irradiation, followed by coating the said flexible sheet with a clearcoat material curable by irradiation with UV light.

11. The process of claim 10, wherein the said clearcoat material is cured thereafter by irradiation with high energy UV light.
